(19) United States
(12) Patent Application Publication
(10) Pub. No.: US 2015/0319357 A1
(43) Pub. Date: Nov. 5, 2015

(54) RANGING APPARATUS, IMAGING APPARATUS, RANGING METHOD AND RANGING PARAMETER CALCULATION METHOD

(71) Applicant: CANON KABUSHIKI KAISHA, Tokyo (JP)

(72) Inventor: Makoto Oigawa, Kawasaki-shi (JP)

(21) Appl. No.: 14/698,285

(22) Filed: Apr. 28, 2015

(30) Foreign Application Priority Data
May 2, 2014 (JP) 2014-095420

(51) Int. Cl. H04N 5/232; H04N 5/14

(52) U.S. Cl. CPC H04N 5/23212; H04N 5/145

(57) ABSTRACT

A ranging apparatus includes: a first calculation unit configured to calculate an image shift amount between a first image and a second image, the first image being based on a first signal which corresponds to a light flux transmitted through a first pupil area of an imaging optical system, and the second image being based on a second signal which corresponds to a light flux transmitted through a second pupil area of the imaging optical system; and a second calculation unit configured to calculate a defocus amount from the image shift amount, using a conversion coefficient based on a received light quantity distribution in accordance with the position of the ranging pixel.

### BACKGROUND OF THE INVENTION

1. Field of the Invention

The present invention relates to a ranging technique, and more particularly to a ranging technique used for a digital still camera, a digital video camera or the like.

2. Description of the Related Art

For the AF (Auto Focus) of a digital still camera or a digital video camera, a method for acquiring a parallax image and detecting the distance (depth) based on the phase difference method is known. A pixel having a ranging function (hereafter called “ranging pixel”) is disposed on a part or on all of the pixels of an image sensor, and optical images generated by light fluxes transmitted through different pupil areas (hereafter called “image A” and “image B”) are acquired. An image shift amount, which is a relative position shift amount of the image A and the image B (also called “parallax”) is calculated, and distance is calculated using a conversion coefficient based on the base line length, which is a center of gravity interval of the light fluxes that form the image A and the image B on the lens pupil.

At this time the quantity of light and the base line length change in the peripheral angle of view are known. In the peripheral angle of view (peripheral region of image), the inclination of the principal ray that enters pixels becomes large, the light receiving efficiency decreases, so that the quantity of light drops. An available technique to improve the light receiving efficiency is to shift a position of a micro-lens on a photo diode (PD) in accordance with the pixel position. Japanese Patent Application Laid-open No. 2007-189312 discloses a method for correcting the output of the PD when the shift amount of the micro-lens changed from the design value due to a fabrication error.

Moreover in the peripheral angle of view, the center of gravity position of the light flux that forms the image A or the image B changes due to the influence of vignetting, which is generated by an eclipse of the lens frame or the like, and the base line length changes. The change of the base line length refers to a change in the conversion coefficient when ranging is performed, which results in a ranging error. For such a change of the base line in the peripheral angel of view, Japanese Patent Application Laid-open No. 2008-268403 discloses a method for correcting the change amount of the center of gravity position of each light flux based on the design information on the optical system.

However the sensitivity characteristic of the PD is shifted from the design characteristic due to an error in the lens or image sensor generated during fabrication. Such a change of the sensitivity characteristic of the PD at each pixel changes the center of gravity position of the light flux to be received, hence the base line length changes accordingly. In other words, the deviation of the micro-lens shift amount from the design value causes a change of the base line length at each pixel from the design value, and the ranging conversion coefficient changes from the design value accordingly, whereby the ranging error is generated.

Japanese Patent Application Laid-open No. 2007-189312 discloses a method for correcting the output from the PD when the received light quantity changed due to an error of the micro-lens shift amount generated during fabrication. However the changed base line length is not corrected, hence the ranging error generated when the distance is calculated from the image shift amount cannot be reduced.

Japanese Patent Application Laid-open No. 2008-268403 discloses a method for correcting the base line length in accordance with the angle of view. However this correction method is based on the design value of the optical system, and therefore an error during fabrication, in particular an error in a base line length generated due to the fabrication error of the micro-lens shift amount, cannot be corrected.

### SUMMARY OF THE INVENTION

It is an object of the present invention to provide a ranging technique that allows to detect the distance at high accuracy, even if the base line length is changed from the design value due to a fabrication error.

A first aspect of the present invention is a ranging apparatus including: a first calculation unit that calculates an image shift amount between a first image based on a first signal which corresponds to a light flux transmitted through a first pupil area of an imaging optical system, and a second image based on a second signal which corresponds to a light flux transmitted through a second pupil area of the imaging optical system; and a second calculation unit that calculates a defocus amount from the image shift amount, using a conversion coefficient based on a received light quantity distribution in accordance with the position of the ranging pixel.

A second aspect of the present invention is a ranging method for a ranging apparatus, including: a first calculation step of calculating an image shift amount between a first image based on a first signal which corresponds to a light flux transmitted through a first pupil area of an imaging optical system, and a second image based on a second signal which corresponds to a light flux transmitted through a second pupil area of the imaging optical system; and a second calculation step of calculating a defocus amount from the image shift amount, using a conversion coefficient based on a received light quantity distribution in accordance with the position of the ranging pixel.

A third aspect of the present invention is a ranging parameter calculation method used for a ranging apparatus, including: a step of acquiring a first signal based on a light flux transmitted through a first pupil area of an imaging optical system, and a second signal based on a light flux transmitted through a second pupil area of the imaging optical system; a step of calculating a received light quantity distribution in accordance with a position of a ranging pixel, based on at least one of the first signal and the second signal; and a step of calculating a conversion coefficient for converting an image shift amount into a defocus amount based on the received light quantity distribution.

According to the present invention, distance can be measured at high accuracy, even if the base line length is changed from the design value due to a fabrication error.

### BRIEF DESCRIPTION OF THE DRAWINGS

Further features of the present invention will become apparent from the following description of exemplary embodiments with reference to the attached drawings.

FIG. 1A to FIG. 1E are diagrams depicting a configuration of an imaging apparatus that includes a distance detection apparatus;

FIG. 2A and FIG. 2B are diagrams depicting a light receiving sensitivity of a pixel in a center area;

FIG. 3A and FIG. 3B are diagrams depicting the light receiving sensitivity of a pixel in a peripheral area;

FIG. 4A to FIG. 4C are diagrams depicting a change of the base line length based on a micro-lens shift error;

FIG. 5A and FIG. 5B are graphs showing the received light quantity distribution under a uniform illumination;

FIG. 6 is a flow chart of the ranging processing to correct the change of the base line length;

FIG. 7A to FIG. 7C are diagrams depicting a case when a micro-lens array as a whole shifts in parallel; and

FIG. 8A to FIG. 8C are diagrams depicting a case when the micro-lens array as a whole shifts toward the center.

### DESCRIPTION OF THE EMBODIMENTS

A method for correcting the base line length and a ranging apparatus that uses the method for correcting the base line length according to an embodiment of the present invention will now be described. In all the drawings, composing elements having the same function are denoted with a same numeral, where redundant description is omitted. An imaging apparatus that includes a distance detection apparatus of the present invention is not limited to the examples that will be described below. For example, the imaging apparatus of the present invention can be applied to an imaging apparatus of a digital video camera, a live view camera or the like, or to a digital distance measurement apparatus.

### Embodiment 1

### Ranging Apparatus, Ranging Method

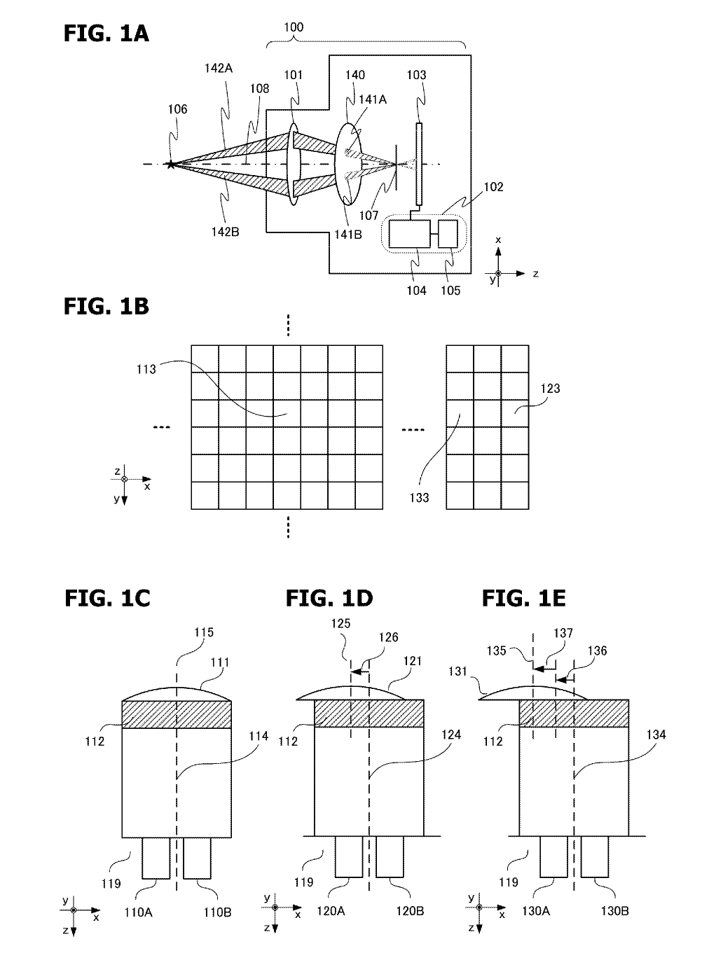

FIG. 1A is a schematic diagram depicting an imaging apparatus 100 that includes a distance detection apparatus according to this embodiment. The imaging apparatus 100 is constituted by an imaging optical system 101, a distance detection apparatus (ranging apparatus) 102, and an image sensor 103. The distance detection apparatus 102 includes a processing unit 104 and a memory 105. In the following description, the optical axis 108 of the imaging optical system 101 is parallel with the z axis. The x axis and the y axis are perpendicular to each other, and are perpendicular to the optical axis 108.

The image sensor 103 is constituted by many ranging pixels (hereafter also simply called “pixels” for brevity), which are arrayed on the xy plane, as depicted in FIG. 1B. A pixel 113 at the center of the image sensor 103 is constituted by a micro-lens 111, a color filter 112, and photoelectric conversion units 110A and 110B as depicted in the cross-sectional views in FIG. 1C. In the image sensor 103, the spectral characteristic in accordance with the detection wavelength band is provided for each pixel by a color filter 112. The pixels in the image sensor 103 are disposed on the xy plane according to a known color pattern (e.g. Bayer array), which is not illustrated. A substrate 119 is made from a material that absorbs light in the detection wavelength band, such as Si. The photoelectric conversion unit is formed in at least a part of the area inside the substrate 118 by ion implantation, for example. Each pixel has a wire, which is not illustrated.

A light flux 142A transmitted through a first pupil area 141A and a light flux 142B transmitted through a second pupil area 141B respectively enter the photoelectric conversion unit 110A and the photoelectric conversion unit 110B. The first pupil area 141A and the second pupil area 141B are mutually different areas in an exit pupil 140. The photoelectric conversion unit 110A and the photoelectric conversion unit 110B receive a first signal and a second signal respectively. In the following description, an image formed by the light flux 142A transmitted through the first pupil area 141A is called “image A”, a pixel that includes the photoelectric conversion unit 110A is called “pixel A”, and a signal acquired from the photoelectric conversion unit 110A is called “first signal”. In the same manner, an image formed by the light flux 142B transmitted through the second pupil area 141B is called “image B”, a pixel that includes the photoelectric conversion unit 110B is called “pixel B”, and a signal acquired from the photoelectric conversion unit 110B is called “second signal”. The signal acquired by each photoelectric conversion unit is transferred to the processing unit 104 where the ranging processing is performed.

An outline of the ranging processing performed by the processing unit 104 will be described. In an image shift amount calculation processing (first calculation processing), the processing unit 104 calculates an image shift amount, which is a relative position shift amount between the image A, which is an image of the first signal, and the image B, which is an image of the second signal. The image shift amount can be calculated using a known method. For example, a correlation value S(k) is calculated from the image signal data A(i) and B(i) of the image A and the image B using Expression 1.

$$S ( j ) = {\sum }_{i = p}^{q} \vert A ( i + j ) - B ( i ) \vert \qquad ( Expression 1 )$$

In Expression 1, S(j) denotes a correlation value that indicates a degree of correlation between two images in the image shift amount j, i denotes a pixel number, and j denotes a relative image shift amount between the two images. P and q denote target pixel ranges used for calculating the correlation value S(j). To calculate the image shift amount, the image shift amount j, by which the correlation value S(j) becomes the minimum, is determined. The method for calculating the image shift amount is not limited to this method, but another known method may be used.

In the distance calculation processing (second calculation processing), the processing unit 104 calculates a defocus amount, which is distance information, from the image shift amount. The image of the object 106 is formed on the image sensor 103 via the imaging optical system 101. In FIG. 1A, the light flux transmitted through the exit pupil 140 forms a focal point on an image forming plane 107, and the focus is defocused. “Defocus” refers to the state where the image forming plane 107 and the imaging plane (light receiving plane) do not match, and are shifted from each other in the optical axis 108 direction. “Defocus amount” refers to a distance between the imaging plane of the image sensor 103 and the image forming plane 107. The distance detection apparatus of this embodiment detects the distance of the object 106 based on the defocus amount. The image shift amount r, which indicates a relative position shift amount between the image A based on the first signal and the image B based on the second signal acquired by each photoelectric conversion unit of the pixel 113, and the defocus amount ΔL, have the relationship shown in Expression 2.

$$Δ L = \frac{rL}{W - r} \qquad ( Expression 2 )$$

In Expression 2, W denotes a base line length and L denotes a distance from the image sensor (imaging plane) 103 to the exit pupil 140. The base line length W corresponds to the center of gravity interval in the pupil sensitivity distribution generated by projecting the later mentioned sensitivity distribution with respect to the incident angle of a pixel on the plane of the exit pupil 140.

If the base line length W>>image shift amount r is established here, the denominator of Expression 2 can be approximated by W, hence the defocus amount ΔL can be expressed as Expression 3 using the conversion coefficient α.

ΔL≅α·r (Expression 3)

A coefficient to convert the image shift amount into the defocus amount is hereafter referred to as “conversion coefficient”. Conversion coefficient refers to the proportion coefficient α or to the base line length W mentioned above. Correction or calculation of the base line length W is synonymous to correction or calculation of the conversion coefficient.

The method for calculating the defocus amount is not limited to the above mentioned method, but may be another known method.

<Micro-Lens Shift and Change of Base Line Length Due to Micro-Lens Shift>

The pixel 113 in the center area of the image sensor 103 is disposed such that the photoelectric conversion units 110A and 110B are symmetric with respect to the center line 114 of the pixel 113, and the center 115 of the micro-lens 111 matches with the center line 114, as depicted in FIG. 1C. FIG. 1D shows a cross-sectional view of a pixel 123 disposed in a peripheral area of the image sensor 103. While the photoelectric conversion units 120A and 120B are disposed symmetrically with respect to the center line 124, the center line 125 of the micro-lens 121 has shifted from the center line 124 toward the center area (−x direction) by the micro-lens shift amount 126. By this micro-lens shift, light can be efficiently guided to the photoelectric conversion units 120A and 120B, even in the peripheral area of the image sensor 103 where the principal rays are inclined from the optical axis 108, thereby the light receiving efficiency can be improved.

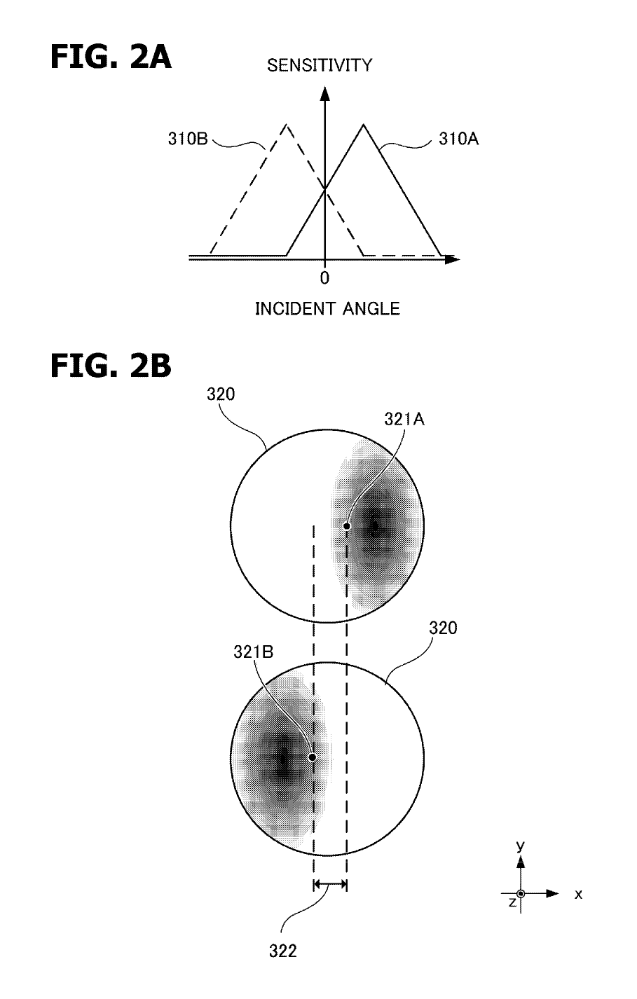

FIG. 2A is a schematic diagram depicting the sensitivity of the pixel 113 in the center area, in which the abscissa indicates the incident angle of the beam with respect to the optical axis 108, and the ordinate indicates the sensitivity of the sensitivity. The solid line 310A indicates the sensitivity of the photoelectric conversion unit 110A that mainly receives the light flux 142A from the first pupil area 141A, and the broken line 310B indicates the sensitivity of the photoelectric conversion unit 110B that mainly receives the light flux 142B from the second pupil area 141B. FIG. 2B shows the pupil sensitivity distribution information that is acquired by projecting the pixel sensitivity shown in FIG. 2A from the pixel 113 onto the exit pupil 140. In FIG. 2B, the pupil shape 320 is a shape of the exit pupil 140 viewed from the pixel 113 via the imaging optical system 101, and the darker the color of the area the higher the sensitivity of the area. The base line length W is a center of the gravity interval 322, which is an interval between the center of gravity position 321A of the pupil sensitivity distribution of the photoelectric conversion unit 110A (first center of gravity position) and the center of gravity position 321B of the pupil sensitivity distribution of the photoelectric conversion unit 110B (second center of gravity position).

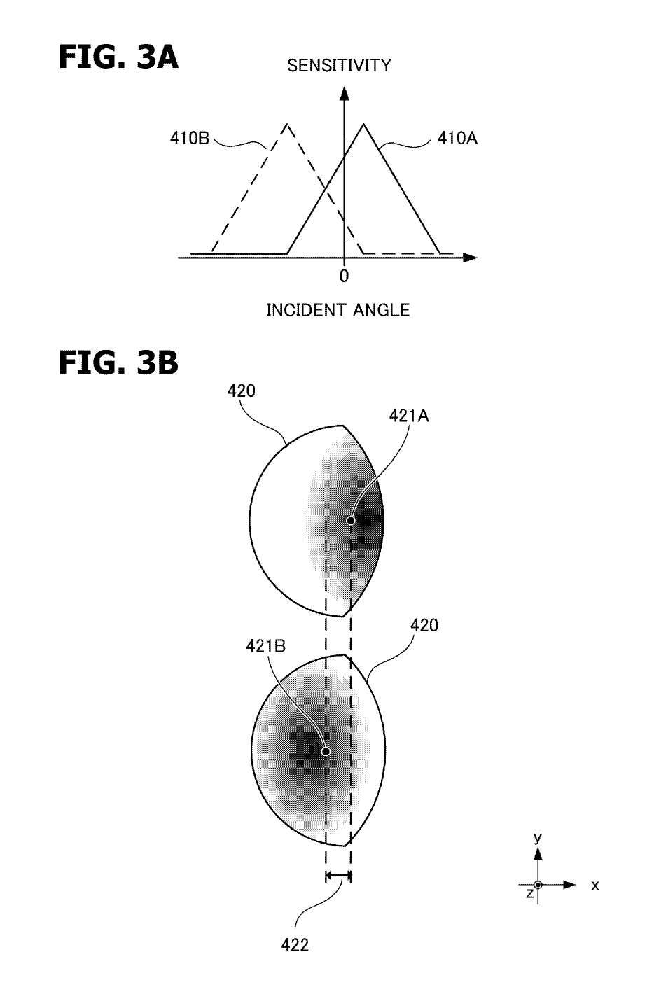

In the same manner, FIG. 3A is a schematic diagram depicting the sensitivity of the pixel 123 in the peripheral area. Although the composition and configuration of the photoelectric conversion units are the same as the pixel 113, the distribution of the incident angle is shifted from FIG. 2A because of the effect of the micro-lens shift. FIG. 3B shows the pupil sensitivity distribution information that is acquired by projecting the pixel sensitivity shown in FIG. 3A from the pixel 123 onto the exit pupil 130. Because this is a peripheral angle of view, the pupil shape 420 is not a circle but is a shape reflecting vignetting due to an eclipse of the lens frame or the like. The pupil sensitivity distribution information has a shape reflecting the influence of the shift of the pixel sensitivity distribution generated by the micro-lens shift and the influence of the change of the pupil shape generated by vignetting. Therefore the center of gravity interval 422, which is the length between the center of gravity positions 421A and 421B of the pupil sensitivity distribution of each photoelectric conversion unit, is different from the center of gravity interval 322 of the pixel 113 in the center area, and the value of the base line length W is also different depending on the pixel position (image height). This means that, to perform highly accurate ranging, a value of the base line length in accordance with the pixel position must be used in the distance calculation processing using Expression 2.

If the base line length is different depending on the pixel position, the above described content of the ranging processing is partially changed. The image shift amount calculation processing is the same as the above described processing, where the image shift amount in the distance calculation target pixel position is calculated. Then the base line length selection processing (third calculation processing) is performed to select the base line length in accordance with the pixel position. In the memory 105, the base line length corresponding to the information of the imaging optical system 101 (F value, exit pupil distance, vignetting value) is stored in advance in table format. The processing unit 104 selects a value of the base line length corresponding to the distance calculation target pixel from the table. In the distance calculation processing, the processing unit 104 performs the ranging processing by Expression 2 using the value of the selected base line length.

<Change of Base Line Length Due to Deviation of Micro-Lens Shift Amount from Design Value, and Ranging Error>

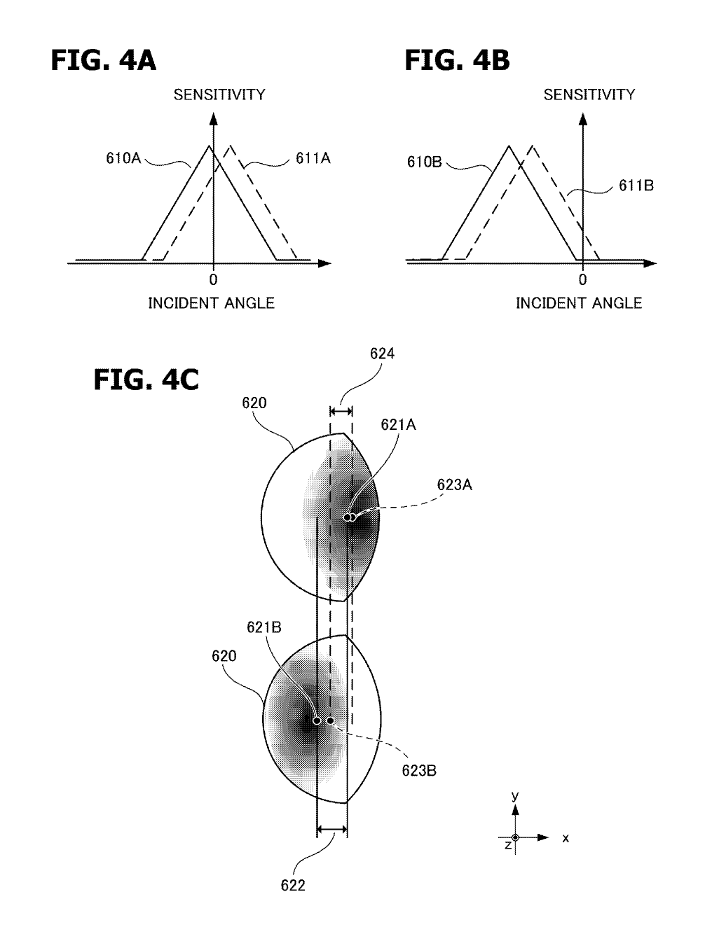

It is assumed that the pixel 133 in FIG. 1B is located near the pixel 123 in the peripheral area of the image sensor 103, and has the same design values as the pixel 123, including pixel sensitivity, but the micro-lens shift amount of the pixel 133 is deviated from the design value due to a fabrication error. FIG. 1E is a cross-sectional view of the pixel 133. The design value of the micro-lens shift amount of the center 135 of the micro-lens 131 from the center line 134, which is the symmetrical line of the photoelectric conversion units 130A and 130B, is the shift amount 136. Actually the micro-lens shift amount shifted from the design value toward the center area (−x direction) by the amount of the micro-lens shift error 137 due to the fabrication error. The solid line 610A in FIG. 4A indicates the sensitivity of the photoelectric conversion unit 130A of the pixel 133, and the solid line 610B in FIG. 4B indicates the sensitivity of the photoelectric conversion unit 130B of the pixel 133. In both cases, comparing with the broken lines 611A and 611B (which are design values), the sensitivity distribution with respect to the incident angle is shifted by the amount corresponding to the micro-lens shift error 137. FIG. 4C shows the pupil sensitivity distribution information that is acquired by projecting the pixel sensitivity shown in FIG. 4A and FIG. 4B from the pixel 133 onto the exit pupil 130. Since the image height of the pixel 133 is regarded as the same as that of the pixel 123, the pupil shape 620 and the pupil shape 420 are similar, equally influenced by vignetting. However the pixel sensitivity distribution shifted due to the influence of the micro-lens shift error 137, therefore the center of gravity position of the pupil sensitivity distribution of each photoelectric conversion unit becomes 621A and 621B indicated by the solid line, which shifted from the center of gravity position 623A and 623B of each design value indicated by the broken line. The center of gravity interval 622 indicated by the solid line is a different value from the center of gravity interval 624 of the design value indicated by the broken line, and the value of the base line length W is changed, and a ranging error is generated by the micro-lens shift error 137. The change amount of the base line length W is determined by the direction and the value of the micro-lens shift error, the shift direction and the shift amount of the pixel sensitivity distribution based on this change of the base line length W, the pupil shape reflecting vignetting, and the change amount of the center of gravity position of the pupil sensitivity distribution projected onto the pupil surface, which is the result of superposition of these pixel sensitivity distributions. In this example, the micro-lens shift error 137 was generated in the −x direction, the pixel sensitivity distribution shifted in the negative angle side and the light was projected onto the exit pupil having the pupil shape 620, and as a result, the center of gravity interval 622 becomes a value greater than the center of gravity interval 624 of the design value. In other words, the base line length W becomes a value greater than the design value, and if the ranging processing to convert the image shift amount into the defocus amount is performed using Expression 2, the calculated distance value is smaller than the actual distance.

In the distance detection apparatus according to this embodiment, the value of the base line length, which changed due to the micro-lens shift error, is corrected, and the ranging processing is performed using the corrected base line length. Thereby the ranging error can be reduced. The base line length correction processing will be described in detail herein below.

<Base Line Length Correction Based on Received Light Quantity Distribution>

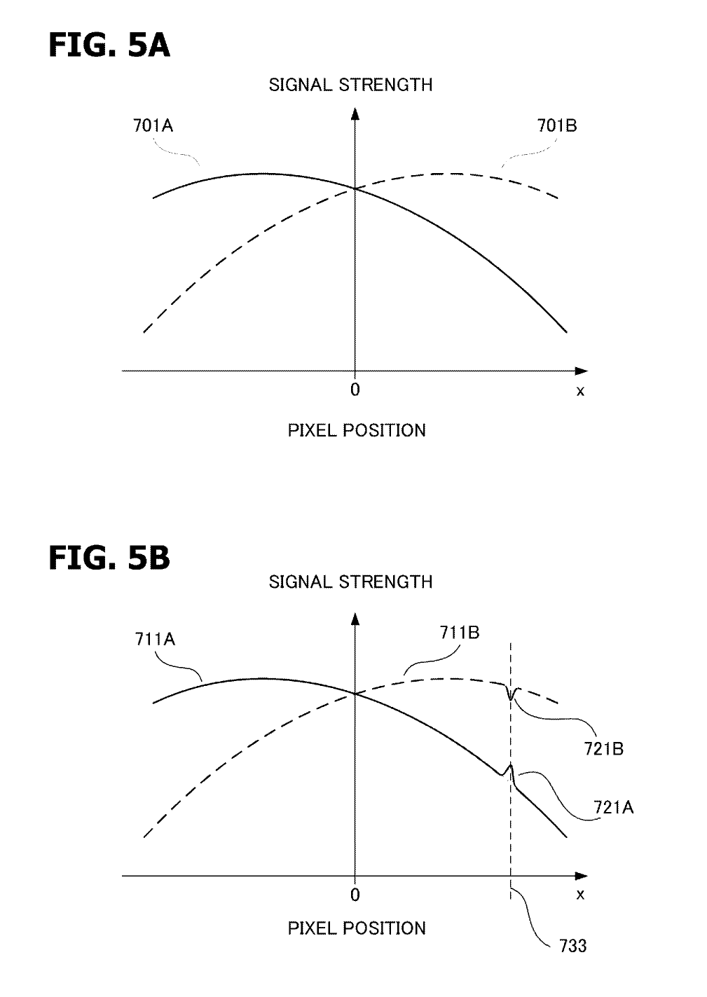

The base line length correction method, for correcting the change of the base line length generated by a fabrication error, will be described. FIG. 5A shows a design value of the received light quantity distribution in the imaging apparatus 100 when illumination, having uniform brightness, is irradiated. The abscissa indicates the positions on the x axis, which is an image height, of the pixels including the pixels 113, 123 and 133, and the ordinate indicates the signal strength outputted from each pixel. The received light quantity distribution 701A indicated by the solid line is a design value of the signal strength outputted from the photoelectric conversion unit corresponding to the pixel A of each pixel of the image sensor 103, and the received light quantity distribution 701B indicated by the broken line is the design value of the signal strength outputted from the photoelectric conversion unit corresponding to the pixel B thereof. The received light quantity distribution, when an object having uniform brightness is photographed, reflects the shading and the pixel sensitivities of the pixel A and the pixel B with respect to the incident angle, and the distribution in accordance with a pixel position (that changes depending on the pixel position).

FIG. 5B shows a received light quantity distribution when illumination, having uniform brightness, is irradiated onto the imaging apparatus 100 according to this embodiment, which has an error in the micro-lens shift amount in pixel 133. The solid line indicates the received light quantity distribution 711A of the pixel A, and the dotted line indicates the received light quantity distribution 711B of the pixel B. The received light quantity distributions 711A and 711B include the received light quantity distribution shifts 721A and 721B respectively in the pixel position 733, which corresponds to the pixel 133 that has a micro-lens shift error 137. Since the received light quantity distribution shifts 721A and 721B are generated by the micro-lens shift error 137, the correction value for the base line length can be acquired by comparing the actual received light quantity in the pixel position 733 and the design value. This base line length correction processing is described next.

The received light quantity in accordance with the position of the pixel on the image sensor changes depending on the magnitude and direction of the micro-lens shift error, and the received light quantity distribution changes accordingly. At the same time, the incident angle characteristic of the pixel sensitivity is shifted depending on the magnitude and direction of the micro-lens shift error, whereby the center of gravity position of the pupil sensitivity distribution, when the light is projected onto the exit pupil, is shifted, and the value of the base line length W changes from the design value. Thus the change amount of the value of the received light quantity distribution in accordance with the position of the pixel on the image sensor and the change amount of the value of the base line length W correspond to each other. Therefore the value of the corrected base line length, generated by correcting the base line length change amount corresponding to the change of the received light quantity distribution, is stored in the memory 105 in advance as a correction value table in accordance with the pixel position. The imaging apparatus 100 calculates the change amount from the design value of the received light quantity distribution acquired under uniform illumination. Then the imaging apparatus 100 determines a value of the corresponding corrected base line length from the calculated change amount of the received light quantity distribution based on the correction value table, and corrects the value of the base line length of the corresponding pixel to the value of the corrected base line length.

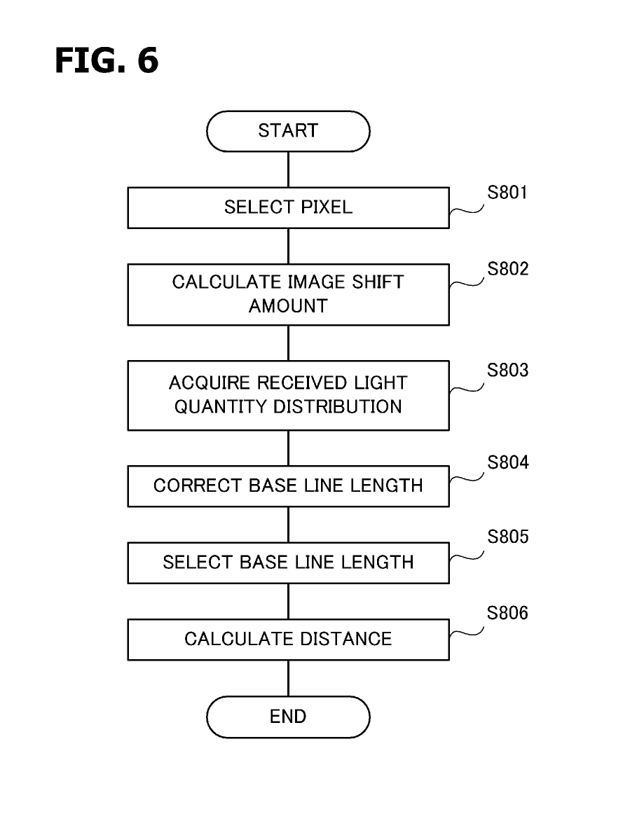

FIG. 6 is a flow chart depicting an example of the ranging processing to correct the change of the base line length due to a fabrication error. In the pixel selection processing in step S601, the processing unit 104 selects a position of the distance calculation target pixel on the image sensor. In the image shift amount calculation processing in step S602, the image shift amount, which is a relative position shift amount between the image A (image of the first signal) and the image B (image of the second signal), is calculated. Since the processing in step S602 has already been described, redundant description is omitted here.

In the received light quantity distribution acquisition processing in step S603, the processing unit 104 acquires the received light quantity distribution with respect to the pixel position, as described above. In the base line length correction processing in step S604, the processing unit 104 calculates the base line length correction value from the change of the received light quantity distribution by the above mentioned processing. In the base line length selection processing in step S605, the processing unit 104 selects a value of the corrected base line length determined in step S604. In the distance calculation processing in step S606, the processing unit 104 calculates the distance using the value of the base line length, including the corrected base line length selected in step S605. The image shift amount calculation processing in step S602 corresponds to the first calculation processing in the present invention. The received light quantity distribution acquisition processing and the base line length correction processing in steps S603 and S604 correspond to the third calculation processing. The base line length selection processing and the distance calculation processing in step S605 and S606 correspond to the second calculation processing.

By calculating the distance like this, using the value of the corrected base line length as the value of the base line length W in the distance calculation processing Expression 2, the ranging error generated by the change of the base line length due to the micro-lens shift error can be reduced.

In the above description, the base line length corresponding to the lens information (F value, exit pupil distance, and vignetting value of the imaging optical system 101) for each pixel position is stored in the memory 105 in a table format in advance, and the base line length stored in the memory 105 is corrected based on the change amount of the received light quantity distribution. However, it is also preferable that only the base line length to be a reference is stored for each pixel position, without providing the base line length corresponding to the lens information in advance, and the base line length is corrected based on the change amount of the received light quantity distribution and the lens information. This method is preferable since the load on the memory can be reduced. Moreover, when the lens is exchanged at an actual photographing location, the base line length correction value can be acquired based on the lens data after the exchange, and the base line length correction processing can be performed in accordance with the photographing conditions.

<Detailed Method for Calculating Base Line Length Change Amount from Received Light Quantity Distribution>

The base line length correction amount can be calculated once the received light quantity distribution is acquired. The received light quantity in each pixel is determined by integrating the incident angle sensitivity characteristic, as shown in FIG. 2A (the abscissa indicates an incident angle, and the ordinate indicates light receiving sensitivity) with the incident angle range to this pixel. The incident angle range is determined by the vignetting of the imaging optical system, which is determined by the pixel location. The shift amount of the incident angle sensitivity characteristic can be calculated such that the calculated change amount matches with the measured change amount of the received light quantity in the incident angle range calculated from the vignetting value of this pixel position. In concrete terms, the integration is computed while moving the center of the integration range but keeping the width of the integration range same as that determined by the vignetting, and the integration range shift amount is calculated such that the integration result matches with the change amount of the measured received light quantity. Then the incident angle sensitivity characteristic is shifted by the same amount as the calculated integration range shift amount, and the incident angle sensitivity characteristic after the shift of this pixel is projected onto the exit pupil, thereby the center of gravity position thereof is determined. The interval of the center of gravity of the pixel A and the pixel B determined in this manner is a value of the corrected base line length. To project the incident angle sensitivity characteristic onto the exit pupil, at least one of: exit pupil position, exit pupil diameter, and F value, is used. It is preferable that the processing unit inside the camera main unit performs this calculation, since the user can perform correction at any photographing opportunity. Further, it is preferable to store the correspondence amount as a data table in terms of reducing load on the processing unit.

The change amount from the design value of the received light quantity distribution can be acquired from the difference of the acquired received light quantity distribution value and the received light quantity distribution value of the design value. This method is preferable in terms of reducing the calculation load. A value other than 0 [zero] in the differences of these received light quantity distribution values is the change amount of the received light quantity distribution, and correspondence with the corrected base line length can be acquired by the method disclosed in the above mentioned method for calculating the base line length change amount.

The change amount from the design value of the received light quantity distribution can also be acquired from the ratio of the value of the acquired received light quantity distribution value and the received light quantity distribution value of the design value. This method is preferable since the change amount can be calculated at high accuracy. A value other than 1 in the ratio of these received light quantity distribution values is the change amount of the received light quantity distribution, and correspondence with the corrected base line length can be acquired by the method disclosed in the above mentioned method for calculating the base line length change amount.

The change amount from the design value of the received light quantity distribution can also be acquired from the comparison of the differential value of the acquired received light quantity distribution and the differential value of the received light quantity distribution of the design value. This method is preferable since the change amount can be calculated at high accuracy. By using the differential values, local change amount, like 721A and 721B in FIG. 5B, can be calculated more easily. If the differential values are compared using the difference or the ratio as described above, correspondence with the corrected base line length can be acquired.

It is also possible to perform only base line length correction processing (steps S801 to S804 in FIG. 6) according to the above mentioned method without performing the ranging processing. In other words, by the above mentioned method, the calibration processing for the ranging apparatus after assembly of the product (ranging parameter calculation processing) can be implemented. This calibration processing is preferable since the ranging performance can be calibrated without reassembly of the product when a fabrication error is detected after the product is assembled.

<Other Factors to Change Base Line Length W>

The factor to change the base line length due to a fabrication error is not limited to a micro-lens shift error. For example, when a pn junction area, which is a photoelectric conversion unit area of PD in the image sensor, is formed in an area deviated from design during fabrication, the relative position with the micro-lens changes, and thus the received light quantity distribution changes. Further, when a wave guide exists between the micro-lens in the image sensor and the PD, and the position of the wave guide is shifted due to a fabrication error, the received light quantity distribution changes. In such a case as well, the method of the present invention can correct the base line length W and reduce ranging error.

<Other Means to Acquire Received Light Quantity Distribution>

To acquire the received light quantity distribution, a method of actually photographing (photographing an arbitrary object) may be used instead of photographing an object with uniform illuminance. In other words, the received light quantity distribution in accordance with the pixel position may be acquired from the signals of the image A and the image B in actual photographing. In this case, a value generated by dividing the image A signal based on the actual photographing by the image B signal based on the actual photographing is compared with a value generated by dividing the received light quantity distribution 701A of the design value by the received light quantity distribution 701B of the design value. However the value generated by the division using the signals of actual photographing has a peak superposed, which caused by the image shift amount of the object, therefore fitting (approximation) by the polynomial of the N-th degree (N: 2 or greater integer) is performed. The change amount of the received light quantity distribution is calculated by comparing the ratio of the image A signal and the image B signal of the design value (701A/701B) with the ratio of the image A signal and the image B signal in the actual photographing after the polynomial approximation. In this processing, the value generated by dividing the image B signal by the image A signal may be used for the comparison. The comparison can be performed by a method using the above mentioned difference, ratio or differential value.

### Embodiment 2

In this embodiment, described will be a base line length correction method for correcting the base line length change due to a fabrication error, which particularly is caused by a parallel shift of the position of the micro-lens array from the design value in the imaging plane all over the surface of the image sensor.

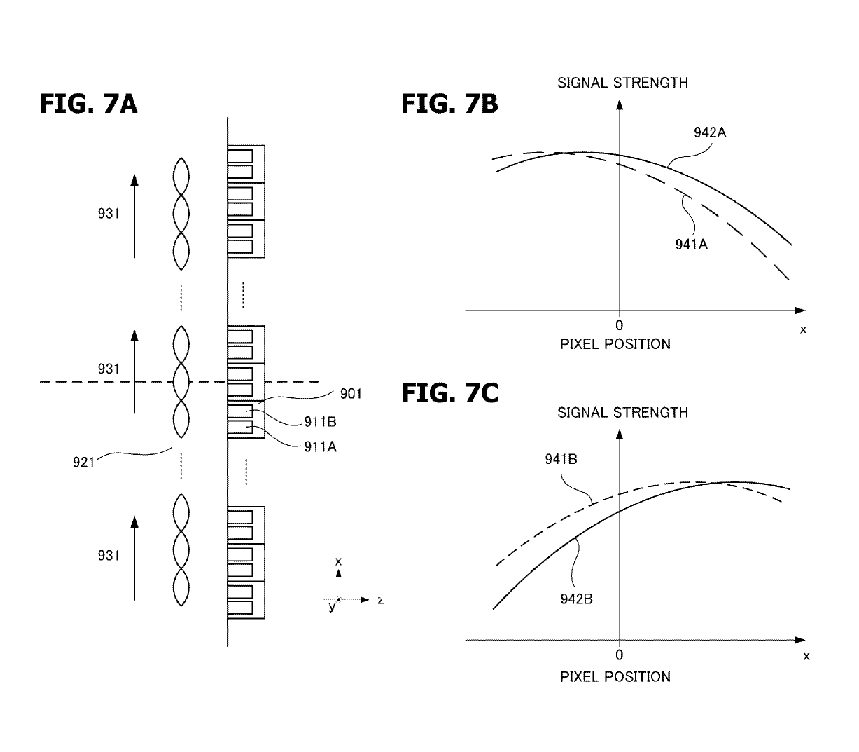

FIG. 7A is a cross-sectional view when the image sensor 103 is viewed from a direction perpendicular to the z axis which is parallel with the optical axis 108. Each pixel (pixel 901) of the image sensor is constituted by a photoelectric conversion unit 911A (pixel A) and a photoelectric conversion unit 911B (pixel B). A micro-lens array 921 is disposed above the photoelectric conversion units, and the position of the micro-lens array 921 is shifted from the design value by a micro-lens shift amount in accordance with the position of each pixel. The micro-lens array has a micro-lens shift error in the shift direction 931, which is parallel with the +x direction on the surface of the imaging plane due to a fabrication error. FIG. 7B and FIG. 7C show the received light quantity distribution in accordance with the pixel position under uniform illumination, where FIG. 7B is the case of the pixel A and FIG. 7C is the case of the pixel B. In the pixel A, the light receiving efficiency of each pixel is changed by the influence of the micro-lens shift error, and the received light quantity distribution 942A to be acquired is shifted in the +x direction from the pixel position of the design value 941A indicated by the broken line. In the pixel B, on the other hand, the light receiving efficiency of each pixel is changed by the influence of the micro-lens shift error, and the received light quantity distribution 942B to be acquired is shifted in the −x direction from the pixel position of the design value 941B indicated by the broken line. The base line length correction processing and the distance calculation processing described in Embodiment 1 can also applied to reduce the ranging error generated by the change of the base line length due to the fabrication error of the micro-lens array shift.

If the direction of the micro-lens shift error is the opposite direction of the shift direction 931, the shift direction of the received light quantity distribution from the design value becomes the opposite.

### Embodiment 3

In this embodiment, described will be a base line length correction method for correcting the base line length change due to a fabrication error, which particularly is caused by a shift (contraction) of the position of the micro-lens array toward the center of the image sensor in the imaging plane all over the surface of the image sensor.

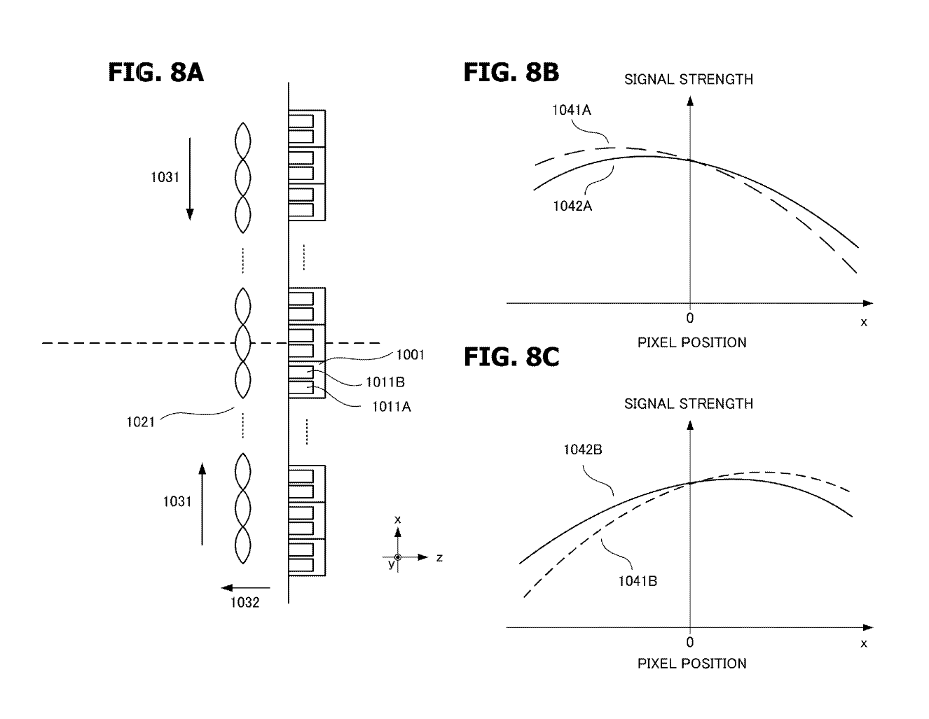

FIG. 8A is a cross-sectional view when the image sensor 103 is viewed from a direction perpendicular to the z axis, which is parallel with the optical axis of the image sensor 103, just like Embodiment 2. Each pixel (pixel 1001) of the image sensor is also constituted by a photoelectric conversion unit 1011A (pixel A) and a photoelectric conversion unit 1011B (pixel B). A micro-lens array 1021 is disposed above the photoelectric conversion units, and the position of the micro-lens array 1021 is shifted from the design value by a micro-lens shift amount in accordance with the position of each pixel. The micro-lens array has a micro-lens shift error in the shift direction 1031, which is a direction toward the center of the image sensor on the surface of the imaging plane, due to the fabrication error of the micro-lens array contraction. In other words, the value of the micro-lens shift value is shifted from the design value in the −x direction if the position of the pixel is +x, and in the +x direction if the position of the pixel is −x. FIG. 8B and FIG. 8C show the received light quantity distribution in accordance with the pixel position under uniform illumination, where FIG. 8B is the case of the pixel A and FIG. 8C is the case of the pixel B. In the pixel A, the light receiving efficiency improves in an area where the pixel position is +x, and the light receiving efficiency drops in the area where the pixel position is −x, due to the influence of a micro-lens shift error. Therefore the received light quantity distribution 1042A to be acquired changes as shown in FIG. 8B from the design value 1041A indicated by the broken line. In the pixel B, on the other hand, the light receiving efficiency drops in the area where the pixel position is +x, and the light receiving efficiency improves in the area where the pixel position is −x, due to the influence of a micro-lens shift error. Therefore the received light quantity distribution 1042B to be acquired changes as shown in FIG. 8C from the design value 1041B indicated by the broken line. The base line length correction processing and the distance calculation processing described in the embodiments can be applied to reduce the ranging error generated by the change of the base line length due to the fabrication error of the micro-lens array contraction.

If the direction of the micro-lens shift error is the opposite direction of the shift direction 1031 (i.e. in case of micro-lens array expansion), the increase/decrease of the received light quantity distribution from the design value becomes the opposite.

The change of the received light quantity distribution similar to this example is also generated when the position of the micro-lens array is shifted in the height direction (z axis direction) of the image sensor due to a fabrication error. If the position of the micro-lens array is shifted from the design value in the shift direction 1032, which is the −z direction, the light receiving efficiency of each pixel increases/decreases in the shift direction 1031 with the same tendency as the case of generation of a micro-lens shift error. If the shift direction is the opposite of the shift direction 1032, the tendency of increase/decrease also becomes the opposite.

### Other Embodiments

The above mentioned distance measurement technique of the present invention can be suitably applied, for example, to an imaging apparatus, such as a digital camera and a digital camcorder, or an image processor and a computer that perform image processing on the image data acquired by the imaging apparatus. The present invention can also be applied to various electronic apparatuses (including a portable phone, a smartphone, a straight type terminal, a personal computer) that encloses the imaging apparatus or the image processor.

The acquired distance information can be used for various image processing operations, such as the area division of an image, the generation of a 3D image and depth image, and the emulation of a blur effect.

The distance measurement technique can actually be installed in the apparatus by software (program) or by hardware. For example, various processing operations to achieve the object of the present invention may be implemented by storing a program in a memory of a computer (e.g. microcomputer, FPGA) enclosed in an imaging apparatus or image processor, and allowing the computer to execute the program. A dedicated processor, such as an ASIC, which implements all or part of processing operations of the present invention using logic circuits, may be disposed.

For this purpose, the program is provided to a computer via a network or via various types of recording media that can be the storage apparatus (computer-readable recording media that holds data non-temporarily). Therefore the computer (including such a device as a CPU and MPU), the method, and the program (including program codes and program products) and the computer-readable recording media that non-temporarily holds the program are all included within the scope of the present invention.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-095420, filed on May 2, 2014, which is hereby incorporated by reference herein in its entirety.

What is claimed is:

1. A ranging apparatus, comprising:
a first calculation unit configured to calculate an image shift amount between a first image and a second image, the first image being based on a first signal which corresponds to a light flux transmitted through a first pupil area of an imaging optical system, and the second image being based on a second signal which corresponds to a light flux transmitted through a second pupil area of the imaging optical system; and
a second calculation unit configured to calculate a defocus amount from the image shift amount, using a conversion coefficient based on a received light quantity distribution in accordance with the position of the ranging pixel.

2. The ranging apparatus according to claim 1, further comprising a third calculation unit configured to calculate the conversion coefficient based on the received light quantity distribution, wherein
the second calculation unit is further configured to calculate the defocus amount from the image shift amount, using the conversion coefficient calculated by the third calculation unit.

3. The ranging apparatus according to claim 2, wherein
the third calculation unit is further configured to
acquire the received light quantity distribution from the first signal or the second signal acquired by photographing an object having uniform brightness, and
calculate the conversion coefficient by comparing the received light quantity distribution with a design value of a received light quantity distribution of the first signal or the second signal acquired when an object having uniform brightness is photographed.

4. The ranging apparatus according to claim 2, wherein
the third calculation unit is further configured to
acquire a ratio of the first signal and the second signal as the received light quantity distribution, and
calculate the conversion coefficient by comparing the received light quantity distribution with a ratio of design values of received light quantity distributions of the first signal and the second signal acquired when an object having uniform brightness is photographed.

5. The ranging apparatus according to claim 2, wherein
the third calculation unit is further configured to calculate the conversion coefficient, using a difference between the received light quantity distribution and a design value of the received light quantity distribution.

6. The ranging apparatus according to claim 2, wherein
the third calculation unit is further configured to calculate the conversion coefficient, using a ratio of the received light quantity distribution and a design value of the received light quantity distribution.

7. The ranging apparatus according to claim 2, wherein
the third calculation unit is further configured to calculate the conversion coefficient using a differential value of the received light quantity distribution with respect to a pixel position and a differential value of the design value of the received light quantity distribution with respect to the pixel position.

8. The ranging apparatus according to claim 2, wherein
the third calculation unit is further configured to calculate the conversion coefficient, also using lens information that includes at least one of an F value, an exit pupil distance and a vignetting value of the imaging optical system.

9. An imaging apparatus, comprising:
an imaging optical system;
an image sensor including a ranging pixel for acquiring and outputting a first signal which corresponds to a light flux transmitted through a first pupil area of the imaging optical system, and a second signal which corresponds to a light flux transmitted through a second pupil area of the imaging optical system; and
the ranging apparatus according to claim 1.

10. A ranging method for a ranging apparatus, comprising:
a first calculation step of calculating an image shift amount between a first image and a second image, the first image being based on a first signal which corresponds to a light flux transmitted through a first pupil area of an imaging optical system, and the second image being based on a second signal which corresponds to a light flux transmitted through a second pupil area of the imaging optical system; and
a second calculation step of calculating a defocus amount from the image shift amount, using a conversion coefficient based on a received light quantity distribution in accordance with the position of the ranging pixel.

11. A ranging parameter calculation method used for a ranging apparatus, comprising:
a step of acquiring a first signal based on a light flux transmitted through a first pupil area of an imaging optical system, and a second signal based on a light flux transmitted through a second pupil area of the imaging optical system;
a step of calculating a received light quantity distribution in accordance with a position of a ranging pixel, based on at least one of the first signal and the second signal; and
a step of calculating a conversion coefficient for converting an image shift amount into a defocus amount, based on the received light quantity distribution.
